(19) United States
(12) Patent Application Publication
(10) Pub. No.: US 2003/0028675 A1
(43) Pub. Date: Feb. 6, 2003

(54) Centralized network storage system, both server and transforming device for the system

(75) Inventors: Ming-Chih Chang, Taipei (TW); Tse-Ming Lin, Taipei (TW)

Correspondence Address: Richard P. Berg, Esq., c/o LANDAS & PARRY, Suite 2100, 5670 Wilshire Boulevard, Los Angeles, CA, 90036-5679, US

(73) Assignee: ICP Electronics Inc.

(21) Appl. No.: 09/997,137

(22) Filed: Nov. 28, 2001

(30) Foreign Application Priority Data
Jul. 31, 2001 (TW) 90118589

(51) Int. Cl. G06F 15/16; G06F 13/38; G06F 13/12

(52) U.S. Cl. 709/250; 709/203; 710/74; 710/72

(57) ABSTRACT

A centralized network storage system comprises a plurality of diskless clients and a server. A transforming device in the client, such as an interface card installed in the IDE or PCI expansion slot of the client, receives a hard disk access command from the client and packs the identity number and the command into a package and delivers the package to a server. A centralized storage device in the server is divided into a plurality of storage areas, each of which respectively corresponds to one of the clients.

After the server receives the package, the server implements the requested access process for the storage area relative to the client represented by the identity number.

### BACKGROUND OF THE INVENTION

1. Field of the Invention

The present invention relates to a technology for information access, and particularly to a centralized network storage system that provides centralized storage through a network without the need of modifying original installed devices or BIOS (Basic Input/Output System).

2. Description of the Related Art

FIG. 1 shows the configuration of a conventional centralized network system for storage. As shown in FIG. 1, the configuration is a basic client-server model comprising: a server 1 and a plurality of clients 2,4,6,8 connected to the server 1 through a network. Clients 2,4,6,8 are diskless systems because the server 1 provides them with a centralized storage. When initiated, the clients build the connection to the server 1 through a network. Thus, the clients can access required information or problem codes to achieve centralized storage management.

However, in this system, the clients must alter the procedure from accessing the local hard disc to accessing centralized storage through a network. Therefore, the original installed devices and BIOS of the clients normally need to be modified. Thus, conventional computers normally can not directly access such a centralized network storage system, without modifying the software and BIOS. Sometimes, such system even requires particular clients (with particular devices and BIOS). Additionally, modification of clients varies with different operating systems (OS). This requires drivers to be modified in different ways according to different operating systems. The development of the prior centralized network storage system having problems has thus become complex and costly.

### SUMMARY OF THE INVENTION

Accordingly, the purpose of the present invention is to provide a centralized network storage system that does not modify the original installed devices or BIOS. The architecture of the system can be used in different operating systems to significantly decrease costs in development and design.

Due to the above purpose, the present invention provides a network storage system that comprises a server and at least one diskless client. A transforming device is disposed in the IDE or PCI expansion slot of the client. It receives the command of accessing the hard disk from the client and packs the command into a package, and a relative identity number will be in the package to identify the client. On the other hand, the server has a centralized storage device which is divided into at least one storage area and each of which corresponds to each client. After unpacking the received package, initiated by the arrival of the access command, the server implements the required access process for the storage area relative to the client represented by the identity number.

The server used in the present centralized network storage system comprises a storage device, an interface circuit and a controller. The storage device is divided into a plurality of storing areas relative to clients. The interface circuit is used to receive packages from clients, wherein one of the packages comprises the identity number that represents the original client and the command of accessing the hard disk. At the initiation of the hard disk access command, the controller implements the access process for the storage area relative to the client represented by the identity number.

The transforming device of the client used in the present centralized network storage system comprises an interface circuit, a logical circuit and a network controller. The interface circuit receives hard disk access commands from a client. The logical circuit receives a hard disk access command and then packs the command and the identity number relative to the client into the same package. The network controller receives the package and delivers it to a server with a storage device.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a diagram illustrating the configuration of the centralized network system for storage as in the prior art;

FIG. 2 is a diagram illustrating the configuration of the centralized network system for storage in the embodiment of the present invention;

FIG. 3 is a block diagram illustrating the first example of the transforming device in the embodiment of the present invention;

FIG. 4 is a block diagram illustrating the second example of the transforming device in the embodiment of the present invention;

FIG. 5 is a schematic diagram illustrating the centralized storage device with a plurality of storage areas in the embodiment of the present invention.

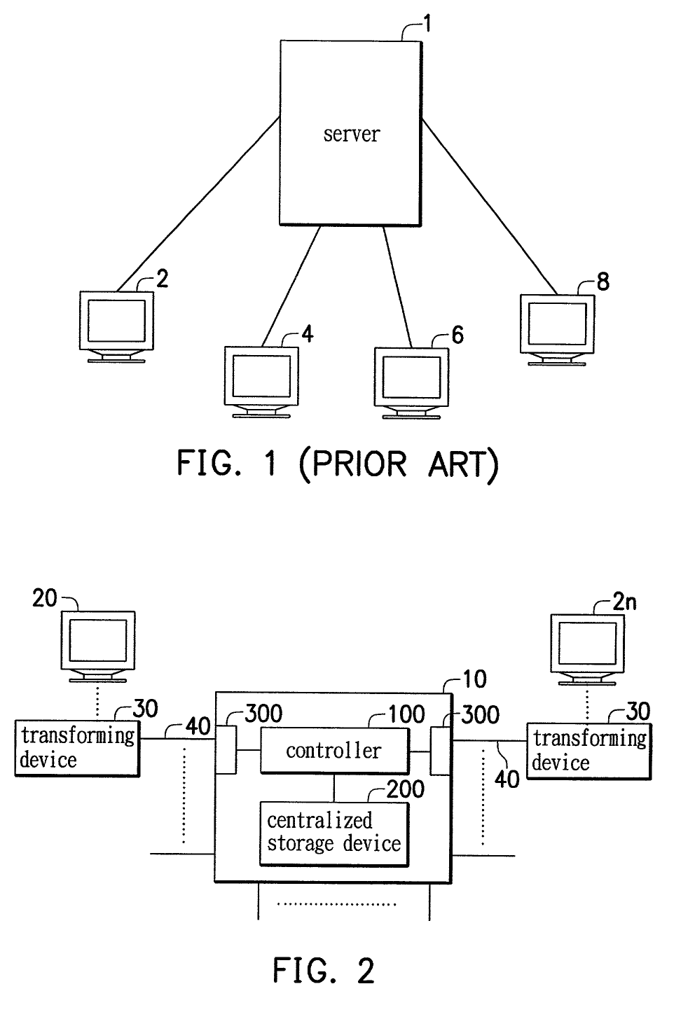

### DETAILED DESCRIPTION OF THE PREFERRED EMBODIMENT

This invention provides a system for fully transparent hard disk access and centralized storage management. The fully transparent access management device that the way of access is the same as access from a local hard disk. Clients themselves do not require any special modification. An access command is transmitted in a unique fashion so the invention decreases design and development costs. Through the following description, the embodiments of the present invention can be understood in conjunction with the accompanying drawings.

FIG. 2 shows the configuration of the centralized network storage system disclosed in the embodiment of the present invention. The centralized network system for storage comprises a server 10, a plurality of clients 20˜2n, and a network line 40 that builds a connection between the server and one client. Clients 20˜2n themselves do not have hard disks, to reduce system cost. In the embodiment, the network line 40 is suitable for all communication protocols used in personal computers such as the Ethernet/LAN (local area network) or wireless communication protocols.

In FIG. 2, each client among the clients 20˜2n has a transforming device 30 which is disposed in an expansion slot that provides an interface for clients 20˜2n to access the centralized storage of the server 10. The transforming device 30 is installed in the expansion slot set up for a hard disk, such as the IDE interface slot widely used in personal computers at present or the PCI interface slot that can expand to other types of hard disks. The transforming device 30 receives the commands that are originally transmitted from a client to the hard disk of the client. Then, the transforming device 30 packs the hard disk access command and the identity number relative to one of the clients 20˜2n into the same package. The package is transmitted to the server 10 through the network line 40. Procedures and processes for the client are identical and, thus, non-discernible from normal HDD access. Beyond the installation of the transforming device 30 and set the relative expansion slot as HD, the clients 20˜2n themselves do not require any special modification.

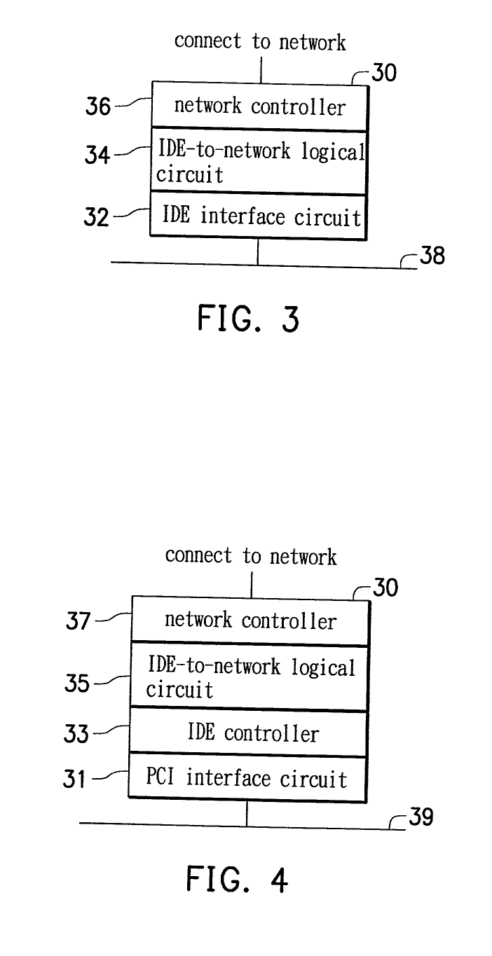

FIG. 3 is a block diagram illustrating the first example for the transforming device 30 in the embodiment of the present invention. The transforming device 30 shown in FIG. 3 is, for this example, installed in an IDE slot 38 of a client. As shown in FIG. 3, the transforming device 30 comprises an IDE interface circuit 32, an IDE-to-network logical circuit 34 and a network controller 36. The IDE interface circuit 32 is used to receive a hard disk access command from one of the clients 20˜2n through IDE slot 38, such as a read, write, or controlling command. The IDE-to-network logical circuit 34 is connected to the IDE interface circuit 32. It receives a hard disk access command and packs the command and the identity number relative to one of the clients 20˜2n into the same package. Finally, through the network controller 36, the package is delivered to the server 10.

FIG. 4 is a block diagram illustrating the second example of the transforming device 30 in the embodiment of the present invention. The transforming device 30 shown in FIG. 4 is, for this example, installed in a PCI slot 39 of a client. As shown in FIG. 4, the transforming device 30 comprises a PCI interface circuit 31, an IDE controller 33, an IDE-to-network logical circuit 35 and a network controller 37. The PCI interface circuit 31 receives a hard disk access command from one of the clients 20˜2n through PCI slot 39. The IDE controller 33 transforms the hard disk access command formed by the format of the PCI bus to the format of the IDE bus. The IDE-to-network logical circuit 35 is connected to the IDE interface circuit 33. It is used to receive a hard disk access command and pack the command and the identity number relative to one of the clients 20˜2n into the same package. Finally, through the network controller 37, the package is delivered to the server 10. The configuration of the transforming device in FIG. 4 is designed by the present circuit to decrease developing time, not to limit the area of the present invention.

Referring again to FIG. 2, the server 10 comprises a controller 100, a centralized storage device 200 and an interface circuit 300. In the storage device 200, the storage space is divided into a plurality of storage areas and each of them separately corresponds to each of the clients 20˜2n for information storage. The interface circuit 300 is used to receive packages from the client 20˜2n. At the initiation of the hard disk access command, the controller 100 can unpack the package to the command of accessing hard disk and the identity number of the client 20. Besides, the controller 100 can run the required accessing process for the storage area relative to the client represented by the identity number.

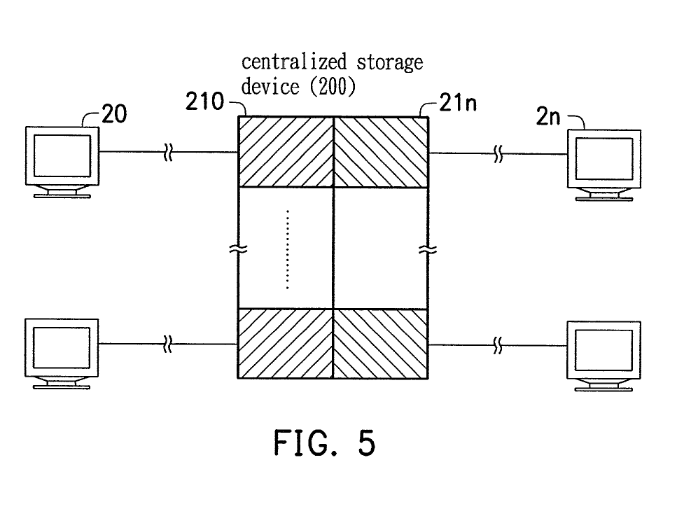

FIG. 5 is a schematic diagram illustrating the centralized storage device 200 with a plurality of storage areas 210˜21n in the embodiment of the present invention, wherein each of the storage areas is set to become a far storage device corresponding to each of the clients 20˜2n.

In normal centralized network storage systems, there are many clients and each of them needs a unique identity number. Thus, in the embodiment of the present invention, the server 10 can distinguish, upon the received package, from which of clients 20˜2n the package originated, and then find the storage area corresponding to the client. After the interface circuit 300 receives the package, the controller 100 unpacks the package to its constituent hard disk access command and identity number. With the identity number, the controller 100 can find the storage area corresponding to the client 20˜2n. In response to the received hard disk access command, the controller 100 performs the requested procedures.

As described above, the centralized network storage system provided by the present invention provides centralized network storage and management without modifying the original devices or BIOS of the client. Because the client software does not require any modification, the diskless system is suitable for a variety of operating systems, thus the system of the present invention decreases design and development costs.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A centralized network storage system, comprising:
at least one diskless client, comprising a transforming device, which receives a hard disk access command from the client and packs the command and an identify number relative to the client into a package; and
a server, connected to the at least one diskless client, comprising a centralized storage device divided into at least one storage area, each of respectively corresponds to each of which the clients; wherein, after unpacking the received package, at the initiation of the hard disk access command contained therein, the server implements a requested disk access process for the storage area relative to the client represented by an identity number contained in the transmitted package.

2. The centralized network storage system of claim 1, wherein the transforming device is an interface card installed in an expansion slot of the diskless client.

3. The centralized network storage system of claim 2, wherein the expansion slot is an IDE slot.

4. The centralized network storage system of claim 2, wherein the expansion slot is a PCI slot.

5. The centralized network storage system of claim 1, wherein the diskless clients are connected to the server through an Ethernet protocol.

6. The centralized network storage system of claim 1, wherein the diskless clients are connected to the server through a wireless transmission protocol.

7. A server used in a centralized network storage system and connected to a plurality of diskless clients, comprising:
a storage device, divided into a plurality of storage areas each of which respectively corresponds to one of a plurality of diskless clients;
an interface circuit, used to receive packages from the diskless clients, each package comprises an identity number that represents one of the diskless clients and a hard disk access command;
a controller, connected between the interface circuit and the storage device, wherein the controller implements A storage area-related process as requested by the client represented by the identity number.

8. The server of claim 7, wherein the interface circuit is an Ethernet interface circuit.

9. The server of claim 7, wherein the interface circuit is a wireless communication interface circuit.

10. A transforming device used in a centralized network storage system and installed in a diskless client, comprising:
An interface circuit, used to receive a hard disk access command from the diskless client;
A logical circuit, connected to the interface circuit to receive a hard disk access command and pack both the command and an identity number unique to the diskless client into a package;
A network controller, connected to the logical circuit to receive the package and deliver it to networks.

11. The transforming device of claim 10, wherein the transforming device is an interface card installed in an expansion slot of the diskless client.

12. The transforming device of claim 11, wherein the expansion slot is an IDE slot and the interface circuit receives the hard disk access command through the IDE slot.

13. The transforming device of claim 11, wherein the expansion slot is a PCI slot and the interface circuit receives the hard disk access command through the PCI slot.
